(19) United States
(12) Patent Application Publication
(10) Pub. No.: US 2015/0339548 A1
(43) Pub. Date: Nov. 26, 2015

(54) PROCESSING FUNCTION PROPOSING APPARATUS, SYSTEM, AND METHOD

(71) Applicants: Akiko KITAYAMA, Kanagawa (JP); Yasuyuki Igarashi, Kanagawa (JP); Daisuke Masui, Tokyo (JP); Daisuke Okada, Saitama (JP); Yuka Saito, Tokyo (JP); Yuto Shibata, Kanagawa (JP); Hiroya Uruta, Tokyo (JP); Naoya Tamura, Kanagawa (JP); Noboru Tamura, Kanagawa (JP); Kazuki Sasayama, Kanagawa (JP); Masashi Taniguchi, Kanagawa (JP); Chan Gu, Tokyo (JP)

(72) Inventors: Akiko KITAYAMA, Kanagawa (JP); Yasuyuki Igarashi, Kanagawa (JP); Daisuke Masui, Tokyo (JP); Daisuke Okada, Saitama (JP); Yuka Saito, Tokyo (JP); Yuto Shibata, Kanagawa (JP); Hiroya Uruta, Tokyo (JP); Naoya Tamura, Kanagawa (JP); Noboru Tamura, Kanagawa (JP); Kazuki Sasayama, Kanagawa (JP); Masashi Taniguchi, Kanagawa (JP); Chan Gu, Tokyo (JP)

(21) Appl. No.: 14/718,606

(22) Filed: May 21, 2015

(30) Foreign Application Priority Data
May 21, 2014 (JP) 2014-105399

(51) Int. Cl. G06K 15/02

(52) U.S. Cl. CPC G06K 15/1803

(57) ABSTRACT

A processing function proposing apparatus includes a status detector that detects a current status of a resource, a request acquisition unit that acquires a composite function requested to be executed from multiple composite functions, each composite function combining multiple unit functions, a function selecting unit to select at least one unit function combined that executes the requested composite function based on the current status of the resource, and a proposing unit that proposes the unit function selected by the function selecting unit.

### CROSS-REFERENCE TO RELATED APPLICATION

This patent application is based on and claims priority pursuant to 35 U.S.C. §119(a) to Japanese Patent Application No. 2014-105399, filed on May 21, 2014 in the Japan Patent Office, the entire disclosure of which is hereby incorporated by reference herein.

### BACKGROUND

1. Technical Field

The present invention relates to a processing function proposing apparatus, system, and method.

2. Background Art

Image forming apparatuses such as printers, copiers, facsimile machines, and multifunction peripherals (MFPs) include an operational display unit including a display and multiple operation keys on which various operations are performed. To perform various functional processing on the image forming apparatus by user operation, various operation keys on the operational display unit are operated to instruct the image forming apparatus to perform intended functional processes browsing the display of the image forming apparatus.

As image forming apparatuses become more sophisticated, combining unit functions in various composite functional processes gets complicated, making it difficult to configure operations suitable for executing the intended composite functional processes.

To cope with this issue, an information processing apparatus has been proposed that processes information on combinations of functions selected by user operation from multiple functions included in the image forming apparatus and includes an acquisition unit that acquires usage history information on functions selected by user operation, an usage history storage unit that stores the usage history information, a calculator to calculate combination information on the frequency with which one function is combined with another function, and a transferring unit that transfers the calculated combination information to the image forming apparatus.

In short, the intention is to enhance operability by calculating the information on combination of functions based on the usage history of functions by user operation and presenting the calculated information.

### SUMMARY

An example embodiment of the present invention provides a novel processing function proposing apparatus that includes a status detector that detects a current status of a resource, a request acquisition unit that acquires a composite function requested to be executed from multiple composite functions, each composite function combining multiple unit functions, a function selecting unit to select at least one unit function combined that executes the requested composite function based on the current status of the resource, and a proposing unit that proposes the unit function selected by the function selecting unit.

Further example embodiments of the present invention provide a processing function proposing system and a processing function proposing method.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating hardware of a MFP as an embodiment of the present invention.

FIG. 2 is a block diagram illustrating functions of the MFP as an embodiment of the present invention.

FIG. 3 is a table illustrating a database associating an apparatus status with a function as an embodiment of the present invention.

FIG. 4 is a diagram illustrating a screen for selecting a copy function as an embodiment of the present invention.

FIG. 5 is a flowchart illustrating a processing function proposal process in a copy process as an embodiment of the present invention.

FIGS. 6A and 6B are diagrams illustrating a suitable function proposition selection screen and a screen after selecting a function as an embodiment of the present invention.

FIG. 7 is a diagram illustrating the suitable function proposition selection screen in case multiple apparatus status that proposes suitable functions occur as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the technology known to a person having ordinary skill in the art described above, while it is just possible to propose a recommended function based on a past function selecting history, it is not considered whether or not the proposed function is executable or suitable for the current apparatus status and status surrounding the apparatus, and it is desired to improve the technology.

For example, in case an image forming apparatus has less sheet remaining, if the recommended function based on the operation history is single-sided printing, it is possible to run out of paper to print all pages of the print job. In this case, duplex printing or consolidated printing could be suitable to save paper. However, in the technology known to a person having ordinary skill in the art, it is difficult to propose such printing process since only usage history by user operation is considered, and it is desired to improve the technology. In addition, in case of charging copy function, in case a charging device has less charge remaining, if it is based on user usage history only, color copy function is recommended. In this case, in the technology known to a person having ordinary skill in the art, it is difficult to propose monochrome copy that could finish copying within the charge remaining even if it could be impossible to finish copying within the charge remaining, and it is desired to improve the technology.

In the following embodiment, an apparatus that proposes combination of unit of processing function suitable for resource status in case of executing multifunction processing that consists of unit of processing function is provided.

### First Embodiment

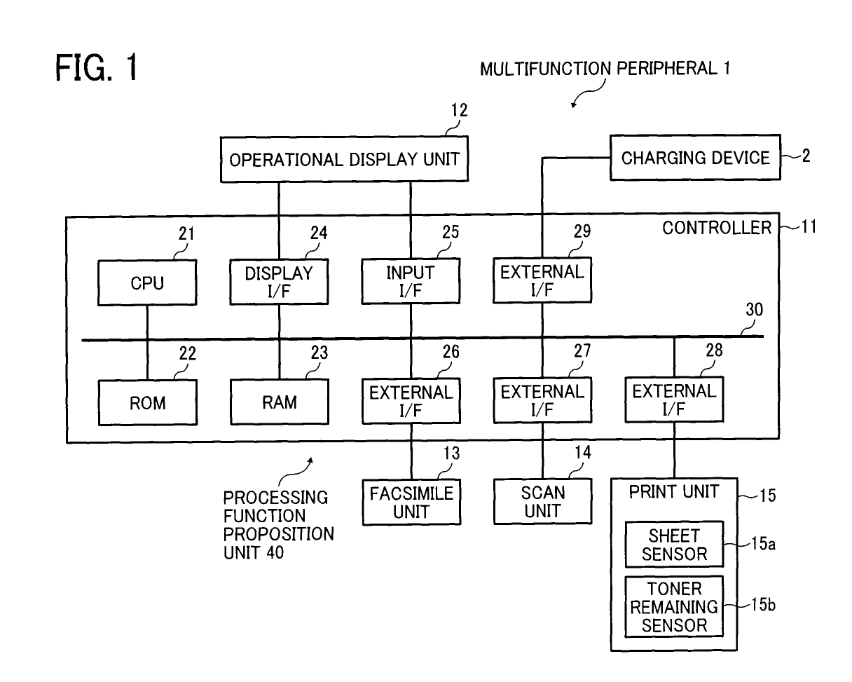

FIG. 1 is a block diagram illustrating hardware of a MFP in this embodiment.

In FIG. 1, a charging device 2 is connected to a MFP 1, and the MFP 1 can be connected to a network (not shown in figures). The MFP 1 includes a controller 11, an operational display unit 12, a facsimile unit 13, a scan unit 14, and a print unit 15 etc.

The controller 11 includes a central processing unit (CPU) 21, a read only memory (ROM) 22, a random access memory (RAM) 23, a display interface (I/F) 24, an input I/F 25, and external I/Fs 26 to 29 etc., and those units are connected to a bus 30.

The charging device 2 is connected to the external I/F 29 of the controller 11, and the external I/F 29 controls outputting information by the charging device 2, acquires information (e.g., money payment information etc.) from the charging device 2, and reports to the CPU 21 about the acquired information etc.

The charging device 2 includes a charge presenter that presents charge for outputting images and a paid amount counter that counts paid money amount in accordance with the presented charge (amount paid by cash or a prepaid card etc.) etc. (not shown in figures).

The CPU 21 passes charge amount information such as image output condition (e.g., image type such as b/w or color, output image size such as size of recording paper etc.) to calculate image output charge to the external I/F 29 and instructs the external I/F 29 to transfer the information to the charging device 2. After acquiring the paid amount count information acquired by the charging device 2 from the external I/F 29, the CPU 21 controls outputting images such as the number of sheets output images, type of output image, and allowance/disallowance of outputting images etc.

The charging device 2 is not limited to the charging device that is located nearby the MFP 1 and accepts payment by cash or prepaid card etc. For example, it is possible that a computer connected to a network functions as the charging device.

The payment amount counter (a status detector) described above acquires current paid amount and current charge status (resource) and output them to the external I/F 29. After receiving the current charge status as resource, the external I/F 29 outputs it to the CPU 21.

The facsimile unit 13 is connected to the external I/F 26 of the controller 11 and a telephone circuit (not shown in figures). After performing facsimile communication with a counterpart facsimile machine via the telephone circuit, the facsimile unit 13 transfers facsimile image data received from the controller 11 via the external I/F 26. In addition, the facsimile unit 13 passes facsimile image data received from the counterpart facsimile machine to the controller 11 via the external I/F 26. The controller 11 instructs the print unit 15 to output the image data received by the facsimile unit 13 on paper. The facsimile unit 13 includes a communication status acquisition unit (status detector) to acquire current resource status such as connection status to the telephone circuit for facsimile communication and communication status of the telephone circuit etc. The external I/F 26 receives the current resource status of the facsimile unit 13 acquired by the communication status acquisition unit and outputs it to the CPU 21.

The scan unit 14 is connected to the external I/F 27 of the controller 11. The scan unit 14 performs main scanning and sub-scanning on a document on which an image is recorded, performs optical/electrical conversion on the image on the document using an optical/electrical conversion element such as charge coupled device (CCD) and complementary metal oxide semiconductor etc., converts into binary image data, and outputs it to the external I/F 27. It is possible that the scan unit 14 includes a scanner status acquisition unit that acquires current operation status and performance etc. of the scan unit 14. The external I/F 27 receives the current status of the scan unit 14 acquired by the scanner status acquisition unit and outputs it to the CPU 21.

Various types of printer can be used as the print unit 15. In this embodiment, electrophotography printer is used as the printer unit 15 and is connected to the external I/F 28 of the controller 11. If the print unit 15 is the electrophotography printer, the paper is transferred from the paper feeding unit that contains multiple number of sheets to the image forming unit one by one under the control of the controller 11. In the print unit 15, the image forming unit forms an electrostatic latent image on the photoconductor based on the image data transferred by the controller 11, develops the electrostatic latent image using toner, and transfers the toner image (a developed image) to the paper. In the print unit 15, the paper on which the toner image is transferred is conveyed to the fixing unit, and the fixing unit transfers the paper on which the toner image is transferred heating and pressurizing to fix the toner image on the paper. The print unit 15 ejects the paper after finishing fixing on the paper output tray.

If the print unit 15 is the electrophotography printer, the print unit 15 includes various sensors to detect status of current resources in the print unit 15, for example, a sheet sensor 15a that detects the number of sheets included in the paper feeding unit and a toner remaining sensor 15b that detects the toner remaining as the developer. If the paper feeding units includes multiple paper trays, the sheet sensor 15a is attached to each of the paper trays. The external I/F 28 receives the current status of the resources in the print unit 15 acquired by the printer status acquisition units such as the sheet sensor 15a and the toner remaining sensor 15b and outputs them to the CPU 21.

As a result, the communication status acquisition unit, the scanner status acquisition unit, the printer status acquisition unit, and the payment amount counter described above as a whole perform a status detection process that detects apparatus status indicating the current status of the resources and function as the status detection unit as described above.

The operational display unit 12 is connected to the display I/F 24 and the input I/F 25 of the controller 11 and includes various operation hardware keys and a display. In the operational display unit 12, a liquid crystal display with a touch panel is used as the display, and display information transferred by the CPU 21 via the display I/F 24 and software keys (function keys) corresponding to various functional modes are displayed on the display. Various command operations such as a sending operation, copying operation, and scanning operation are performed using the hardware keys and the function keys, and the input I/F 25 acquires the operational content and outputs it to the CPU 21.

In the controller 11, programs such as an operating system of the MFP 1, a process function proposal program, and an image processing program in this embodiment and desired system data are stored in the ROM 22. The CPU 21 uses the RAM 23 as a work memory based on the program stored in the ROM 22 and controls the whole of the MFP 1 to perform a basic process as the MFP 1 and a process function proposal method and an image processing method in this embodiment.

The RAM 23 is used as the work memory of the CPU 21 and as an image memory for processing image data for forming an image by the print unit 15. In addition, drawing data for one page after processing images is expanded in the RAM 23.

The status detection unit that detects the current status of a resources in the controller 11, the charging device 2, the facsimile unit 13, the scan unit 14, and the print unit 15 and the operation display unit 12 as a whole function as a process function proposal unit 40.

The MFP 1 in this embodiment is constructed as an image processing apparatus and the process function proposal unit 40 that performs the process function proposal method and the image processing method that proposes combination of process function units suitable for status of resources in executing multifunction process combining multiple predetermined process function units (described later) by reading and installing the process function proposal program that perform the process function proposal method and the image processing program that performs the image processing method in this embodiment stored in a computer-readable recording medium such as a ROM, Electrically Erasable and Programmable Read Only Memory (EEPROM), EPROM, flash memory, flexible disk, Compact Disc Read Only Memory (CD-ROM), Compact Disc Rewritable (CD-RW), Digital versatile Disk (DVD), Secure Digital (SD) card, and Magneto-Optical (MO) Disc in the ROM 22 etc. The process function proposal program and the image processing program are computer-executable programs written in legacy programming languages and object-oriented programming languages such as assembler, C, C++, C#, and Java etc., and the power supply control program can be distributed by storing in the recording medium described above.

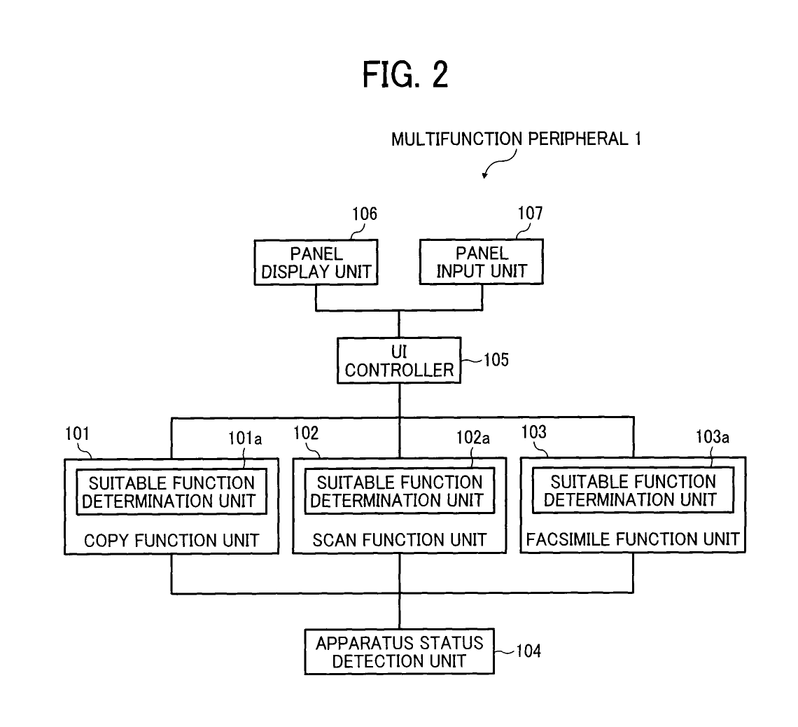

In the MFP 1, functional blocks in FIG. 2 are implemented by installing and executing the process function proposal program and the image processing program described above. That is, as shown in FIG. 2, in the MFP 1, various composite function units such as a copy function unit 101, a scan function unit 102, a facsimile function unit 103, suitable function determination units 101a, 102a, and 103a, an apparatus status detector 104, an UI controller 105, a panel display unit 106, and panel input unit 107 etc. are implemented.

The apparatus status detector (status detecting unit) 104 is implemented by the communication status acquisition unit described above, a scanner status acquisition unit, a printer status acquisition unit, and a payment amount counter etc. and detects the current status of resources. For example, the communication status acquisition unit acquires status of facsimile communication such as a connection status to the telephone circuit for facsimile communication and communication status of the telephone circuit as status of resources. In addition, the scanner status acquisition unit acquires current scanner status such as current operational status and performance of the scan unit 14 as status of resources. Furthermore, the printer status acquisition unit acquires current printer status such as output of the sheet sensor 15a and the toner remaining sensor 15b as status of resources. In addition, the payment amount counter acquires the current paid amount of money as status of resources.

The apparatus status detector 104 outputs the acquired current status of resources to the copy function unit 101, the scan function unit 102, the facsimile function unit 103, and the panel display unit 106.

The panel display unit (a proposal unit) 16 is constructed by the display of the operation display unit 12 and displays information passed from the UI controller 105. Especially, the panel display unit 16 displays information to prompt to select a composite function such as copy, scan, and facsimile by user operation and to propose unit functions suitable for the selected composite function.

The panel input unit 107 is constructed by function keys and operational keys displayed on the display of the operational display unit 12 and outputs content of key operations to the UI controller 105.

The UI controller 105 is constructed by the display I/F 24 and the input I/F 25. The UI controller 105 outputs display information from the copy function unit 101, the scan function unit 102, and the facsimile function unit 103 to the panel display unit 106 and outputs input information from the panel input unit 107 to the copy function unit 101, the scan function unit 102, and the facsimile function unit 103.

The copy function unit 101 includes a suitable function determination unit 101a, and the copy function unit 101 is implemented by executing a copy application and the process function proposal program among image processing applications included in the MFP 1 by the CPU 21. By cooperating the scan unit 14 and the print unit 15 with the CPU 21 as the image processor, the copy function unit 101 performs a copy function (a composite function) that performs image processing on image data acquired by scanning a document image at a predetermined resolution using the scan unit 14 and outputs it on the paper using the print unit 15. The copy function unit 101 executes combined multiple unit functions to perform the copy function. For example, the copy function unit 101 performs the copy function in combination with unit functions such as a single-sided printing function, a duplex printing function, a monochrome printing function, a color printing function, a toner-saving printing function, an image consolidating process function, and an image rotating process function etc.

The scan function unit 102 includes a suitable function determination unit 102a, and the scan function unit 102 is implemented by executing a scan application and the process function proposal program among image processing applications included in the MFP 1 by the CPU 21. By cooperating the scan unit 14 and the RAM 23 with the CPU 21 as the image processor, the scan function unit 102 scans a document image at a predetermined resolution using the scan unit 14. The scan function unit 102 performs a scanner function that performs desired image processing on the scanned image data using the CPU 21 and stores the processed data in the RAM 23. The scan function unit 102 executes combined multiple unit functions to perform the scanner function. For example, the scan function unit 102 performs the scanner function in combination with unit functions such as a monochrome scanning function, a color scanning function, a designated resolution scanning function, a resolution conversion image processing function, and an image rotation processing function etc.

The facsimile function unit 103 includes a suitable function determination unit 103a, and the facsimile function unit 103 is implemented by executing a facsimile application and the process function proposal program among image processing applications included in the MFP 1 by the CPU 21. By cooperating the scan unit 14, the RAM 23, and the CPU 21 as the image processor with the facsimile unit 13, the facsimile function unit 103 performs a facsimile sending process that performs desired image processing on the image data of the document scanned by the scan unit 14 and sends a facsimile to a designated destination. In addition, by cooperating the facsimile unit 13, the RAM 23, and the CPU 21 with the print unit 15, the facsimile function unit 103 performs a facsimile receiving process that performs desired image processing on the image data received by the facsimile unit 15 and outputs the image on the paper using the print unit 15. The facsimile function unit 103 executes combined multiple unit functions to perform the facsimile receiving function and the facsimile sending function as the composite functions. For example, the facsimile function unit 103 performs the facsimile sending function in combination with unit functions such as a monochrome scanning function, a color scanning function, a designated resolution scanning function, a resolution conversion image processing function, and an image compression function etc. In addition, the facsimile function unit 103 performs the facsimile receiving function in combination with unit functions such as an image extending function, a resolution conversion image processing function, an image consolidation processing function, a color printing function, and a monochrome printing function etc.

The suitable function determination unit 101a proposes combination of functions suitable for current apparatus status at least for the copy function. The suitable function determination unit 102a proposes combination of functions suitable for current apparatus status at least for the scanner function. The suitable function determination unit 103a proposes combination of functions suitable for current apparatus status at least for the facsimile function.

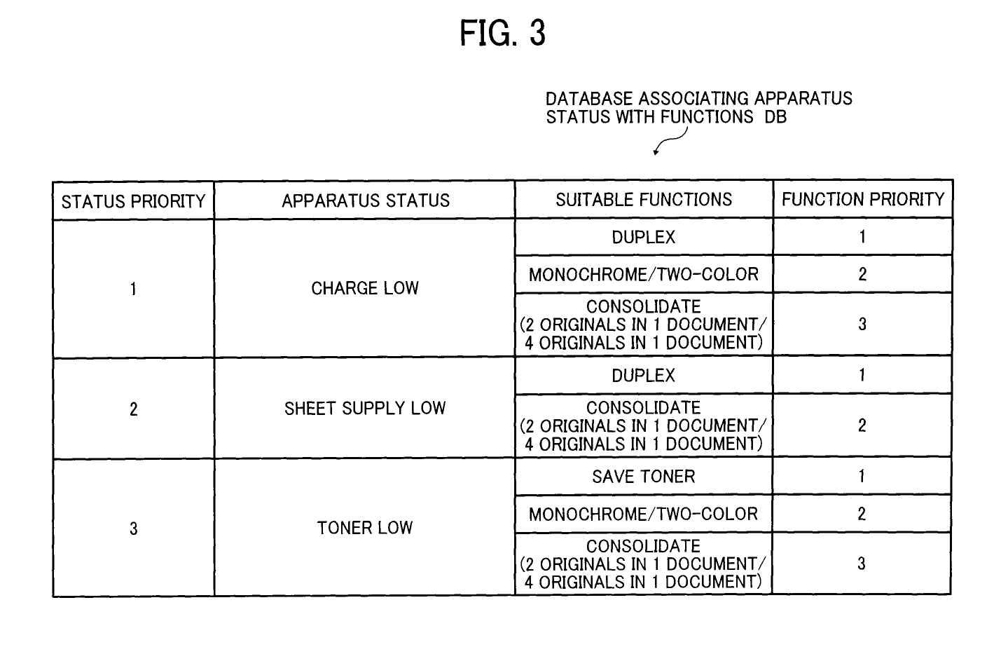

For example, the suitable function determination unit 101a in the copy function unit 101 includes a database associating apparatus status with current apparatus status. In FIG. 3, in the database associating apparatus status with functions DB in the suitable function determination unit 101a, apparatus status that the charge remaining of the charging device 2 is less than predetermined amount of money (e.g., 100 yen), sheet remaining is less than a predetermined number of sheets, and toner remaining is less than predetermined amount are described. The database associating apparatus status with functions DB is stored in a memory such as the ROM 22, the RAM 23, and a nonvolatile memory (not shown in figures) etc. As a result, the memory functions as a status priority storing unit that stores apparatus status as resource status setting priorities and a function priority storing unit that stores multiple processing function units corresponding to the apparatus status as the resource status setting priorities.

To select more suitable function (suitable unit functions) corresponding to the copy function etc. as the composite function, status priorities are set to multiple apparatus statuses. The suitable functions are assigned to each of the apparatus statuses. While one or more suitable functions are preassigned to the apparatus status, it is possible to configure suitable functions appropriately by user operation on the operational display unit 12 etc. In addition, if multiple suitable functions are assigned to one apparatus status, function priorities are assigned to the suitable functions to determine more suitable function in accordance with the apparatus status.

The suitable function determination units 101a, 102a, and 103a selects the suitable function with reference to the database associating apparatus status with functions DB based on the apparatus status as the current resource status that the apparatus status detector 104 detects (acquires) or the apparatus status and the past function selection history information by user operation.

As a result, the suitable function determination units 101a, 102a, and 103a as a whole performs a function selection process that selects function processing units combined to perform requested multifunction process such as the copy function, scanner function, and facsimile function etc. based on the current apparatus status as the resource status and functions as a function selection unit.

In addition, the copy function unit 101, the scan function unit 102, and the facsimile function unit 103 as a whole performs a function execution process that executes the copy function, the scanner function, and the facsimile function as multi image processing functions that combines multiple predetermined image processing functional units and functions as a function execution unit.

As described above, the panel display unit 106 proposes the processing function units selected by the suitable function determination units 101a, 102a, and 103a and functions as a proposal unit.

Among multiple composite processing functions, the UI controller 105 and the panel input unit 107 performs a request acquisition process that acquires requested composite processing function and functions as a request acquisition unit as a whole.

The UI controller 105 and the panel input unit 107 performs a executed function acquisition process that acquires an image processing function unit selected as an executed image processing function unit from image processing function units proposed by the panel display unit 106 as the proposal unit and functions as an executed function acquisition unit as a whole.

The suitable function determination units 101a, 102a, and 103a performs an execution control process that combines the executed image processing function units acquired by the executed function acquisition unit as the image processing function unit of the requested multi image processing units and instructs the copy function unit 101, the scan function unit 102, and the facsimile function unit 103 to execute the combined image processing function unit and functions as an execution controller.

Next, workings in this embodiment are described below. The MFP 1 in this embodiment proposes the combination of the processing function units suitable for the apparatus status in executing the composite processing functions that consists of multiple predetermined processing function units using the current apparatus status as the appropriate resource.

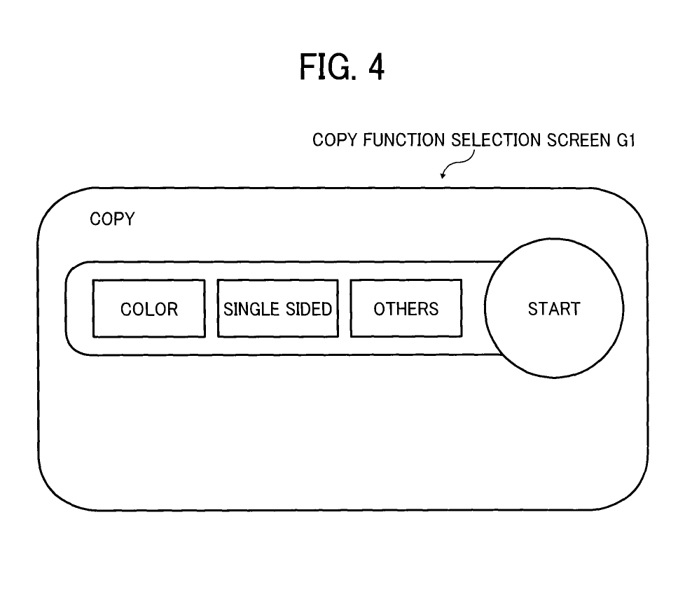

The MFP 1 includes a copy function, a scanner function, a facsimile function, and a data transfer function etc. as composite processing functions. The MFP 1 executes the composite processing functions described above by combining unit functions. For example, if the copy function is selected on the panel input unit 107 by user operation, in the MFP 1, the UI controller 105 usually requests the copy function unit 101 to execute unit functions desired for executing the copy function. In case of not selecting suitable functions, for example, based on usage history of unit functions in the past copy functions by user operation, the copy function unit 101 selects unit functions desired for executing the copy function and outputs the selected unit functions to the UI controller 105. The UI controller 105 instructs the panel display unit 106 to display selectable unit functions among unit functions received from the copy function unit 101 on a display of the operational display unit 12. For example, a copy function selection screen G1 in FIG. 4 is displayed. In FIG. 4, in the copy function selection screen G1, a color copy function (a color scanner function and a color print function), a single-sided print function, and other unit functions along with a start button are displayed.

However, in selecting the unit functions desired for executing the composite function, as described above, if the unit functions are selected based on the usage history of past user operation only, it is possible that the selected unit functions cannot be executed depending on the apparatus status, and the composite function cannot be executed appropriately.

For example, with less color toner remaining or less charge amount remaining etc., it is possible that color copying is not executed appropriately.

To cope with this issue, in the MFP 1 in this embodiment, if the composite function is selected, the suitable function determination unit 101a, 102a, or 103a of the selected composite function selects and proposes the combination of suitable unit functions based on the current apparatus status (resource status) detected by the apparatus status detector 104.

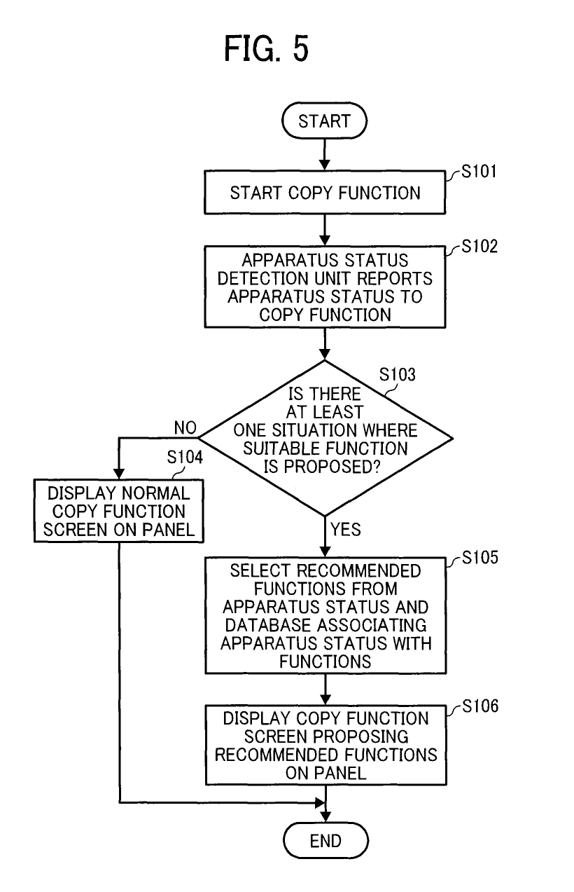

That is, for example, in the MFP 1, if the copy function is selected on the panel input unit 107, as shown in FIG. 5, the UI controller 105 notifies the copy function unit 101 that the copy function is selected and starts the copy function unit 101 in S101. It should be noted that the copy function is selected as the composite function in the below description. However, it is possible to apply the case to other composite functions such as the scanner function and the facsimile function etc. similarly.

In the copy function unit 101, the suitable function determination unit 101a acquires the current apparatus status (resource status) from the apparatus status detector 104 in S102. As described above, the current apparatus status is a resource status acquired by the communication status acquisition unit in the facsimile unit 13, the scanner status acquisition unit in the scan unit 14, the printer status acquisition unit in the print unit 15, and the payment amount counter in the charging unit 2.

The suitable function determination unit 101a checks whether or not there is one or more suitable unit function to be proposed based on the current apparatus status in S103. That is, the suitable function determination unit 101a determines whether or not there is one or more apparatus status that gets to a configuration status configured that the suitable function is to be proposed among the acquired apparatus status. For example, the suitable function determination unit 101a determines whether or not there is one or more status related status that gets to the configuration status that the charge remaining of the charging device 2 as the charging status acquired by the payment amount counter is equal to predetermined amount of money (e.g., 200 yen) and the sheet remaining is equal to or less than a predetermined configured number of sheets (e.g., 10) etc.

If there is not one or more status to propose the suitable function (NO in S103), the suitable function determination unit 101a passes a normal function selection screen for the copy function to the UI controller 105. The UI controller 105 instructs the panel display unit 106 to display a normal copy function selection screen G1 in FIG. 4 for example on the display of the operational display unit 12 in S104, and the process ends.

If there is one or more status to propose the suitable function (YES in S103), the suitable function determination unit 101 selects the suitable function with reference to the database associated apparatus status with function DB based on the apparatus status that gets to the configuration status in S105.

For example, if there is one apparatus status (resource status) that gets to the configuration status to propose the suitable function, the suitable function determination unit 101a selects the suitable function (suitable unit functions) with reference to the database associated apparatus status with function DB considering the apparatus status. More specifically, if there is less sheet remaining, the suitable function determination unit 101a selects a unit function with higher function priority among suitable functions such as duplex printing and consolidated printing (consolidating two originals in one document or four originals in one document).

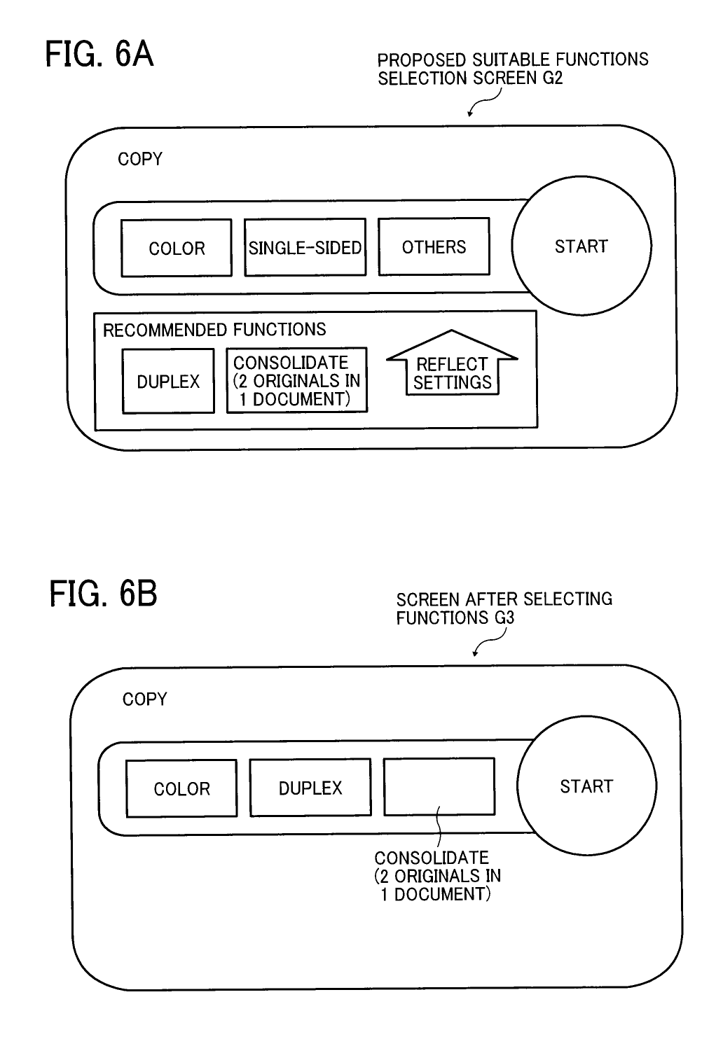

After selecting the suitable function, the suitable function determination unit 101a passes a suitable function proposal selection screen that includes the normal unit functions and the suitable functions of the copy function to the UI controller 105. For example, as shown in FIG. 6A, the UI controller 105 instructs the panel display unit 106 to display a suitable function proposal selection screen G2 on the display of the operational display unit 12 in S106. As shown in FIG. 6A, in the suitable function proposal selection screen G2, normal multiple unit functions for copying, suitable functions, a setting button to reflect the suitable function on the copy function, and a start function button are displayed. In FIG. 6A, the suitable functions based on one apparatus status are displayed as “recommended functions”.

In addition, if there are two apparatus status (resource status) that get to the configuration status to propose the suitable function, the suitable function determination unit 101a selects the suitable function with reference to the database associated apparatus status with function DB considering those apparatus status. More specifically, if the sheet remaining and the charge remaining get to the configuration status, the suitable function determination unit 101a selects a unit function with higher function priority among suitable functions such as duplex printing and consolidated printing (consolidating two originals in one document or four originals in one document) etc. for the sheet remaining and selects a unit function with higher function priority among suitable functions such as duplex printing, monochrome/two-color printing, and consolidated printing (consolidating two originals in one document or four originals in one document) etc. for the charge remaining of the charging device.

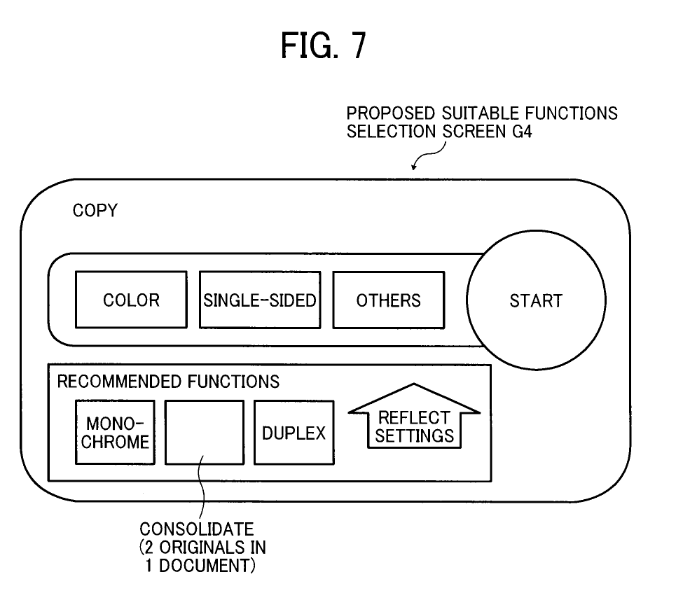

After selecting the suitable function, the suitable function determination unit 101a passes a suitable function proposal selection screen that includes the normal unit functions and the suitable functions of the copy function to the UI controller 105. For example, as shown in FIG. 7, the UI controller 105 instructs the panel display unit 106 to display a suitable function proposal selection screen G4 on the display of the operational display unit 12 in S106. As shown in FIG. 7, in the suitable function proposal selection screen G4, normal multiple unit functions for copying, suitable functions, a setting button to reflect the suitable function on the copy function, and a start function button are displayed. In FIG. 7, the suitable functions based on two apparatus status are displayed as “recommended functions”.

If the setting button on the suitable function proposal selection screen G2 is pressed, the panel input unit 107 recognizes the touch operation and reports to the UI controller 105 about the recognition result. The UI controller 105 notifies the suitable function determination unit 101a that the setting button is operated.

After the setting button is operated, the suitable function determination unit 101a configures functions replacing corresponding unit functions among normal copy unit functions with the suitable functions and passes the configured copy function selected screen to the UI controller 105.

After receiving the copy function selected screen, for example, as shown in FIG. 6B, the UI controller 105 instructs the panel display unit 106 to display the copy function selected screen G3 on the display of the operational display unit 12. In FIG. 6B, unit functions such as “color”, “single-sided”, and “others” are replaced with unit functions such as “color”, “duplex”, and “consolidate (2 originals in 1 document)”.

On the copy function selected screen G3, if the start function button is pressed, the panel input unit 107 recognizes the user operation on the start function button and reports to the UI controller 105 about the recognition result. The UI controller 105 notifies the suitable function determination unit 101a that the start function button is operated.

After the start function button is operated, the suitable function determination unit 101a reports to the copy function unit 101 about the unit functions in the copy function selected screen G3, and the copy function unit 101 performs the copy function that consists of the combination of the unit functions.

As described above, in the MFP 1 in this embodiment, the processing function proposal unit 40 includes an apparatus status detector (a status detecting unit) 104 that detects the current status of a resource used for executing a composite processing function by combining multiple predetermined unit processing functions, a request acquisition unit that includes a UI controller 105 and a panel input unit 107 that acquire a requested composite processing function among multiple composite processing functions, suitable function determination units (function selecting units) 101a, 102a, and 103a that selects unit processing functions to be combined to execute the requested composite processing function based on a current resource status, and a panel display unit (proposal unit) 106 that proposes the unit processing function that the suitable function determination units 101a, 102a, and 103a selects.

As a result, it is possible to propose a combination of unit processing functions appropriate for executing the composite processing functions such as the copy function, scanner function, and facsimile function combining multiple unit processing functions such as the single-sided print function, duplex print function, monochrome print function, color print function, toner saving print function, image consolidating process function, and image rotating process function etc. using appropriate resources such as charged money, paper, toner, and telephone circuit etc.

In addition, the MFP 1 in this embodiment includes the function execution units such as the copy function unit 101, the scan function unit 102, and the facsimile function unit 103 that executes the composite image processing function combining multiple predetermined unit image processing functions using appropriate resources, the apparatus status detector (status detector) 104 that detects the current statuses of the resources, the request acquisition unit that consists of the UI controller 105 and the panel input unit 107 that acquires the composite image processing function requested to execute, the suitable function determination units (function selection units) 101a, 102a, and 103a that selects the unit image processing functions combined to execute the composite image processing function requested to execute based on the current statuses of the resources, the panel display unit (proposal unit) 106 that proposes the unit image processing functions selected by the suitable function determination units 101a, 102a, and 103a, the UI controller (executed function acquisition unit) 105 that acquires the unit image processing function selected to be executed from the unit image processing functions that the panel display unit 106 proposes, and the suitable function determination units (execution controllers) 101a, 102a, and 103a that combines the executed unit image processing function acquired by the UI controller 105 as the unit image processing functions of the composite image processing function requested to execute and instructs the function execution units such as the copy function unit 101, scan function unit 102, and the facsimile function unit 103 to execute the combined executed unit image processing function.

As a result, it is possible to propose the combination of the unit processing functions suitable for the statuses of the resources in executing the composite processing function that consists of multiple unit processing functions using the appropriate resources and execute the composite processing function combining appropriate unit processing functions.

In addition, the MFP 1 and the processing function proposer 40 further includes a memory (status priority storage unit) that stores the status of resource configuration priorities, and the suitable function determination units (function selection units) 101a, 102a, and 103a select the unit processing functions based on the current statuses of the resources and their priorities.

As a result, it is possible to select the unit processing function based on the prioritized statuses of the resources, and it is possible to select the unit processing function suitable for the current statuses of the resources more appropriately.

In addition, the MFP 1 and the processing function proposer 40 further includes a memory (function priority storage unit) that stores the multiple unit processing functions corresponding to the statuses of the resource configuration priorities, and the suitable function determination units (function selection units) 101a, 102a, and 103a selects the unit processing functions based on the current statuses of the resources and the priorities of the unit processing functions corresponding to the statuses of the resources.

As a result, it is possible to select the unit processing function based on the priority assigned to the unit processing function if there are multiple unit processing functions for the status of the resources, and it is possible to select the unit processing function suitable for the current statuses of the resources more appropriately.

Furthermore, in the MFP 1 and the processing function proposer 40 in this embodiment, the suitable function determination units (function selection units) 101a, 102a, and 103a select multiple unit processing functions for one status of the resource.

As a result, it is possible to select the detailed unit processing function for the status of the resource more appropriately, and it is possible to select the unit processing function suitable for the current status of the resource more appropriately.

The present invention also encompasses a non-transitory recording medium storing a program that executes a processing function proposing method. The processing function proposing method, performed by processing function proposing apparatus, includes the steps of detecting a current status of a resource, acquiring a composite function requested to be executed from multiple composite functions, each composite function combining multiple unit functions, selecting at least one unit function combined to execute the requested composite function based on the current status of the resource, and proposing the unit function selected by the function selecting unit.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor. A processing circuit also includes devices such as an application specific integrated circuit (ASIC) and conventional circuit components arranged to perform the recited functions.

What is claimed is:

1. A processing function proposing apparatus, comprising:
a status detector to detect a current status of a resource;
a request acquisition unit to acquire a composite function requested to be executed from multiple composite functions, each composite function combining multiple unit functions;
a function selecting unit to select at least one unit function combined to execute the requested composite function based on the current status of the resource; and
a proposing unit to propose the unit function selected by the function selecting unit.

2. The processing function proposing apparatus according to claim 1, further comprising a status priority storing unit to set and store the priority of the status of the resource,
wherein the function selecting unit selects the unit function based on the current status of the resource and its priority.

3. The processing function proposing apparatus according to claim 1, further comprising a function priority storing unit to set and store multiple unit functions corresponding to the status of the resource,
wherein the function selecting unit selects the unit function based on the current status of the resource and the priority of the unit function corresponding to the status of the resource.

4. The processing function proposing apparatus according to claim 1, wherein the function selecting unit selects multiple unit functions for one status of the resource.

5. The processing function proposing apparatus of claim 1, wherein the composite function is a composite image processing function combining multiple unit image processing functions.

6. A processing function proposing system, comprising:
an information processing apparatus; and
an image processing apparatus,
wherein the information processing apparatus includes:
a status detector to detect a current status of a resource;
a request acquisition unit to acquire a composite function requested to be executed from multiple composite functions, each composite function combining multiple unit functions;
a function selecting unit to select at least one unit function combined to execute the requested composite function based on the current status of the resource; and
a proposing unit to propose the unit function selected by the function selecting unit.

7. The processing function proposing system according to claim 6, wherein the image processing apparatus includes:
a function executing unit to execute the composite image processing function combining multiple unit image processing functions using a resource;
an executed function acquisition unit to acquire the selected unit image processing function to be executed from the unit image processing functions proposed by the proposing unit; and
an execution controller to combine the executed unit image processing function acquired by the executed function acquisition unit as the unit image processing functions of the requested composite image processing function to be executed by the function executing unit.

8. The processing function proposing system according to claim 7, further comprising a status priority storing unit to set and store the priority of the status of the resource,
wherein the function selecting unit selects the unit image processing function based on the current status of the resource and its priority.

9. The processing function proposing system according to claim 7, further comprising a function priority storing unit to set and store multiple unit image processing functions corresponding to the status of the resource,
wherein the function selecting unit selects the unit image processing function based on the current status of the resource and the priority of the unit image processing function corresponding to the status of the resource.

10. The processing function proposing system according to claim 7, wherein the function selecting unit selects multiple unit image processing functions for one status of the resource.

11. A method of proposing a processing function, comprising the steps of:
detecting a current status of a resource;
acquiring a composite function requested to be executed from multiple composite functions, each composite function combining multiple unit functions;
selecting at least one unit function combined to execute the requested composite function based on the current status of the resource; and
proposing the unit function selected by the function selecting unit.
